(19) United States
(12) Patent Application Publication
(10) Pub. No.: US 2023/0209490 A1
(43) Pub. Date: Jun. 29, 2023

(54) METHOD FOR RADIO ACCESS NETWORK INFORMATION EXPOSURE

(71) Applicant: ZTE Corporation, Shenzhen (CN)

(72) Inventors: Jinguo ZHU, Shenzhen (CN); Xingyue ZHOU, Shenzhen (CN); Shuang LIANG, Shenzhen (CN)

(73) Assignee: ZTE Corporation, Shenzhen (CN)

(21) Appl. No.: 17/991,147

(22) Filed: Nov. 21, 2022

Related U.S. Application Data
(63) Continuation of application No. PCT/CN2020/091887, filed on May 22, 2020.

(51) Int. Cl. H04W 60/04; H04W 8/18; H04W 8/02; H04W 76/10

(52) U.S. Cl. CPC H04W 60/04; H04W 8/02; H04W 8/18; H04W 76/10

(57) ABSTRACT

A wireless communication method for use in a network exposure function is provided. The wireless communication method comprises receiving, from a session management function of a core network, a subscription address in a radio access network, transmitting, towards the subscription address in the radio access network, a subscription request, and receiving, from the radio access network, radio access network information corresponding to the subscription request.

### PRIORITY

This application claims priority as a Continuation of PCT/CN2020/091887, filed on May 22, 2020, entitled “METHOD FOR RADIO ACCESS NETWORK INFORMATION EXPOSURE”, published as WO 2021/109488 A1, the entirety of which is incorporated herein by reference.

### TECHNICAL FIELD

Multi-access edge computing (MEC) enables running MEC applications at the edge of the network where the environment is characterized by low latency, proximity, high bandwidth and exposure to location and up-to-date radio access network information. The radio access network information on current radio conditions are shared via MEC platforms over a radio network information service (RNIS). The RNIS is a service that provides radio network related information to the MEC applications and to the MEC platforms. Typical information that may be provided via the MEC platforms is listed as follows:
up-to-date radio access network information regarding radio network conditions;
measurement information related to the user plane (e.g. latency);
information about user equipments (UEs) connected to the radio node(s) associated with the MEC host, these UEs′ context and the related radio access bearers;
changes on information related to the UEs connected to the radio node(s) associated with the MEC host, these UEs′ context and the related radio access bearers.

### BACKGROUND

The MEC applications and the MEC platform may use the radio access network information to optimize the existing services and to provide new type of services that are based on up to date information on the radio conditions.

### SUMMARY

FIG. 1 shows a schematic diagram of a network architecture. In FIG. 1, the network architecture comprises the following network components and/or network functions:
1) UE: User Equipment
2) RAN: Radio Access Network
3) SMF: Session Management Function

The SMF includes the following functionalities: session establishment, modification and release, UE internet protocol (IP) address allocation & management (including optional authorization functions), selection and control of user plane (UP) function, downlink data notification, etc.

4) AMF: Access and Mobility Management function

The AMF includes the following functionalities: Registration management, connection management, reachability management and mobility management. The AMF may also perform access authentication and access authorization. In addition, the AMF is non-access-stratum (NAS) security termination and relays session management (SM) NAS between the UE and the SMF.

5) UPF: User Plane Function

The UPF includes the following functionalities: serving as an anchor point for intra-/inter-radio access technology (RAT) mobility, packet routing & forwarding, traffic usage reporting, quality-of-service (QoS) handling for the UP, downlink packet buffering and downlink data notification triggering, etc.

6) NEF: Network Exposure Function

The NEF supports exposure of capability and events of the network towards the application function (AF). The third-party applications can invoke the service provided by the network via the NEF and the NEF performs authentications and authorizations of the third-party applications. The NEF also provides translation of the information exchanged with the AF and information exchanged with the internal network function. As shown in FIG. 1, the RNIS may be combined with the functions of the NEF.

7) AF: Application Function

The AF interacts with a core network (not shown in FIG. 1) in order to provide services, such as supporting application influence on traffic routing, accessing network exposure function, interacting with the policy framework for policy control. etc. The AFs may be considered to be trusted by the network operator and can be allowed to interact directly with relevant network functions. The AFs, which are not allowed by the operator to directly access the relevant network functions, may use an external exposure framework via the NEF to interact with the relevant network functions. In FIG. 1, the AF may be MEC applications or MEC platforms which are the consumers of the radio access network information.

8) PCF: Policy Control Function

The PCF provides policy rules to control plane functions to enforce the policy rules. Specifically, the PCF provides access and mobility related policy to the AMF and the AMF enforces the provided policy during mobility procedure. In addition, the PCF may provide UE access selection and protocol data unit (PDU) session selection related policies (e.g. UE policy) to the AMF and the AMF forwards them to the UE. Moreover, the PCF may provide session management related policies to SMF and the SMF enforce them. The PCF may be deployed in a distributed manner and each distributed PCF may support different functions in the same public land mobile network (PLMN). After receiving request from the AF, the PCF uses UE address or UE identity to bind the request to associated PDU sessions and to accordingly update the application management (AM) policy or session management (SM) policy.

9) UDR, Unified Data Repository

The UDR supports the storage and retrieval of subscription data by a unified data management (UDM) (not shown in FIG. 1), storage and retrieval of structured data for exposure, application data (including packet flow descriptions (PFDs) for application detection, AF request information for multiple UEs, etc.), storage and retrieval of NF Group ID corresponding to subscriber identifier (e.g. IP Multimedia Subsystem (IMS) Private User Identity (IMPI) and/or IMS Public User Identity (IMPU)). The UDR is located in the same PLMN as the NF service consumers storing in and retrieving data from the UDR by using a Nudr interface.

In FIG. 1, the UE, the RAN, the AMF, the SMF, the UPF, the PCF, the NEF, the AF and the UDR are communicated by using corresponding interfaces. For example, the UE communicates with the RAN via a Uu interface, the RAN communicates the AMF via an N2 interface, and so on.

In the existing technology, there is no direct interface between the NEF (RNIS) and the RAN. Thus, how the NEF (RNIS) obtains the radio access network information from the RAN becomes a topic to be discussed.

This document relates to methods, systems, and devices for radio access network information exposure, and in particular to methods, systems, and devices for providing radio access network information from the RAN to the NEF (RNIS).

The present disclosure relates to a wireless communication method for use in a network exposure function. The wireless communication method comprises:
receiving, from a session management function of a core network, a subscription address in a radio access network,
transmitting, towards the subscription address in the radio access network, a subscription request, and
receiving, from the radio access network, radio access network information corresponding to the subscription request.

Various embodiments may preferably implement the following features:

Preferably, the wireless communication method further comprises:
receiving, from an application function of the core network, radio access network information request for the radio access network information, and
transmitting, to a unified data repository, a subscription container comprising the radio access network information request and a notification address in the network exposure function for the radio access network information.

Preferably, the radio access network information request comprises at least one of information related to the radio access network or at least one event related to the radio access network.

Preferably, the subscription request comprises at least one event related to the radio access network.

Preferably, the at least one event related to the radio access network comprises at least one of detecting a cell change, detecting a radio access bearer event related to a radio access bearer, wherein the radio access bearer event comprises at least one of establishment, a modification or a release, performing a measurement of a wireless terminal, configuring carrier aggregation for a wireless terminal, or expiry of the subscription request.

Preferably, the wireless communication method further comprises:
receiving, from the session management function, quality-of-service flow binding information,
receiving, from the wireless terminal, the radio access network or a user plane function, at least one quality-of-service flow identifier, and
transmitting, to an application function, the radio access network information based on the quality-of-service binding information and the at least one quality-of-service flow identifier.

Preferably, the quality-of-service flow binding information comprises service data flow information and quality-of-service flow identifier associated to the service data flow information.

The present disclosure relates to a wireless communication method for use in a radio access network. The wireless communication method comprises:
transmitting, to a session management function, a subscription address in the radio access network,
receiving, from a network exposure function, a subscription request, and
transmitting, to the network exposure function, radio access network information based on the subscription request.

Various embodiments may preferably implement the following features:

Preferably, the wireless communication method further comprises receiving, from an access and mobility management function, a subscription container comprising a radio access network information request and a notification address of the network exposure function for the radio access network information.

Preferably, the radio access network information request comprises at least one of information related to the radio access network or at least one event related to the radio access network.

Preferably, wherein the subscription request comprises at least one event related to the radio access network.

Preferably, the at least one event related to the radio access network comprises at least one of detecting a cell change, detecting a radio access bearer event related to a radio access bearer, wherein the radio access bearer event comprises at least one of establishment, a modification or a release, performing a measurement of a wireless terminal, configuring carrier aggregation for a wireless terminal, or expiry of subscription container.

Preferably, the wireless communication method further comprises transmitting, to the network exposure function, at least one quality-of-service flow identifier and the radio access network information.

The present disclosure relates to a wireless communication method for use in a session management function. The wireless communication method comprises:
receiving, from a radio access network, a subscription address in the radio access network, and
transmitting, to a network exposure function, the subscription address in the radio access network.

Various embodiments may preferably implement the following features:

Preferably, the wireless communication method further comprises:
receiving, from a policy control function, a subscription container comprising a radio access network information request and a notification address in the network exposure function, and
transmitting, to the radio access network, the subscription container.

Preferably, the wireless communication method further comprises transmitting, to a user plane function, forwarding information comprising the notification address in the network exposure function.

Preferably, the radio access network information request comprises at least one of information related to the radio access network or at least one event related to the radio access network.

Preferably, the subscription request comprises at least one event related to the radio access network.

Preferably, the at least one event related to the radio access network comprises at least one of detecting a cell change, detecting a radio access bearer event related to a radio access bearer, wherein the radio access bearer event comprises at least one of establishment, a modification or a release, performing a measurement of a wireless terminal, configuring carrier aggregation for a wireless terminal, or expiry of the subscription request.

Preferably, the wireless communication method further comprises transmitting, to the network exposure function, quality-of-service flow binding information.

Preferably, the quality-of-service flow binding information comprises service data flow information and quality-of-service flow identifier associated to the service data flow information.

The present disclosure relates to a wireless communication method for use in a radio access network, the wireless communication method comprising:
receiving, from an access and mobility management function, a subscription container comprising a radio access network information request and a notification address of a network exposure function, and
transmitting, to a user plane function, radio access network information based on the subscription container.

Various embodiments may preferably implement the following features:

Preferably, the radio access network information request comprises at least one of information related to the radio access network or at least one event related to the radio access network.

Preferably, the at least one event related to the radio access network comprises at least one of detecting a cell change, detecting a radio access bearer event related to a radio access bearer, wherein the radio access bearer event comprises at least one of establishment, a modification or a release, performing a measurement of a wireless terminal, configuring carrier aggregation for a wireless terminal, or the network information request expires.

Preferably, the wireless communication method further comprises transmitting, to the user plane function, at least one quality-of-service flow identifier associated to the radio access network information.

Preferably, the wireless communication method further comprises receiving, from a session management function, information of configuring a dedicated quality-of-service flow for transmitting the radio access network information.

The present disclosure relates to a wireless communication method for use in a user plane function. The wireless communication method comprises:
receiving, from a session management function, forwarding information comprising a notification address in a network exposure function for receiving radio access network information.
receiving, from a radio access network, the radio access network information, and
transmitting, to the network exposure function, the radio access network information based on the forwarding information.

Various embodiments may preferably implement the following features:

Preferably, the wireless communication method further comprises:
receiving, from the radio access network, at least one quality-of-service flow identifier associated to the radio access network information, and
transmitting, to the network exposure function, the at least one quality-of-service flow identifier.

Preferably, the wireless communication method further comprises receiving, from a session management function, information of configuring a dedicated quality-of-service flow for receiving the radio access network information.

The present disclosure relates to a network device. The network device comprises a communication unit, configured to:
receive, from a session management function of a core network, a subscription address in a radio access network,
transmit, towards the subscription address in the radio access network, a subscription request, and
receive, from the radio access network, radio access network information corresponding to the subscription request.

Various embodiments may preferably implement the following feature:

Preferably, the network device further comprises a processor configured to perform a wireless communication method of any of the foregoing described methods.

The present disclosure relates to a radio access network. The radio access network comprises a communication unit, configured to:
transmit, to a session management function, a subscription address in the radio access network,
receive, from a network exposure function, a subscription request, and
transmit, to the network exposure function, radio access network information based on the subscription request.

Various embodiments may preferably implement the following feature:

Preferably, the radio access network further comprises a processor configured to perform a wireless communication method of any of the foregoing described methods.

The present disclosure relates to a network device. The network device comprises a communication unit, configured to:
receive, from a radio access network, a subscription address in the radio access network, and
transmit, to a network exposure function, the subscription address in the radio access network.

Various embodiments may preferably implement the following feature:

Preferably, the network device further comprises a processor configured to perform a wireless communication method of any of the foregoing described methods.

The present disclosure relates to a radio access network. The radio access network comprises a communication unit, configured to:
receive, from an access and mobility management function, a subscription container comprising a radio access network information request and a notification address of a network exposure function,
transmit, to a user plane function, radio access network information based on the subscription container.

Various embodiments may preferably implement the following feature:

Preferably, the radio access network further comprises a processor configured to perform a wireless communication method of any of the foregoing described methods.

The present disclosure relates to a network device. The network device comprises a communication unit, configured to:
receive, from a session management function, forwarding information comprising a notification address in a network exposure function for receiving radio access network information.
receive, from a radio access network, the radio access network information, and
transmit, to the network exposure function, the radio access network information based on the forwarding information.

Various embodiments may preferably implement the following feature:

Preferably, the network device further comprises a processor configured to perform a wireless communication method of any of the foregoing described methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows a schematic diagram of network structure.

FIG. 2 shows an example of a schematic diagram of a wireless terminal according to an embodiment of the present disclosure.

FIG. 3 shows an example of a schematic diagram of a wireless network node according to an embodiment of the present disclosure.

FIG. 4 shows a schematic diagram of a process according to an embodiment of the present disclosure.

FIG. 5 shows a schematic diagram of a process according to an embodiment of the present disclosure.

FIG. 6 shows a schematic diagram of a process according to an embodiment of the present disclosure.

FIG. 7 shows a schematic diagram of a process according to an embodiment of the present disclosure.

FIG. 8 shows a flowchart of a process according to an embodiment of the present disclosure.

FIG. 9 shows a flowchart of a process according to an embodiment of the present disclosure.

FIG. 10 shows a flowchart of a process according to an embodiment of the present disclosure.

FIG. 11 shows a flowchart of a process according to an embodiment of the present disclosure.

FIG. 12 shows a flowchart of a process according to an embodiment of the present disclosure.

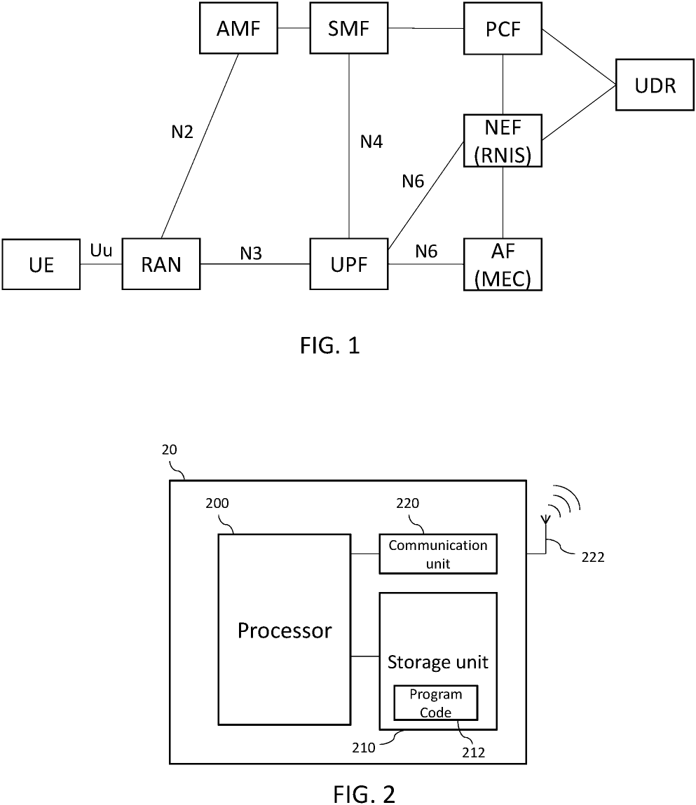

### DETAILED DESCRIPTION

FIG. 2 relates to a schematic diagram of a wireless terminal 20 according to an embodiment of the present disclosure. The wireless terminal 20 may be a user equipment (UE), a mobile phone, a laptop, a tablet computer, an electronic book or a portable computer system and is not limited herein. The wireless terminal 20 may include a processor 200 such as a microprocessor or Application Specific Integrated Circuit (ASIC), a storage unit 210 and a communication unit 220. The storage unit 210 may be any data storage device that stores a program code 212, which is accessed and executed by the processor 200. Embodiments of the storage unit 212 include but are not limited to a subscriber identity module (SIM), read-only memory (ROM), flash memory, random-access memory (RAM), hard-disk, and optical data storage device. The communication unit 220 may a transceiver and is used to transmit and receive signals (e.g. messages or packets) according to processing results of the processor 200. In an embodiment, the communication unit 220 transmits and receives the signals via at least one antenna 222 shown in FIG. 2.

In an embodiment, the storage unit 210 and the program code 212 may be omitted and the processor 200 may include a storage unit with stored program code.

The processor 200 may implement any one of the steps in exemplified embodiments on the wireless terminal 20, e.g., by executing the program code 212.

The communication unit 220 may be a transceiver. The communication unit 220 may as an alternative or in addition be combining a transmitting unit and a receiving unit configured to transmit and to receive, respectively, signals to and from a wireless network node (e.g. a base station).

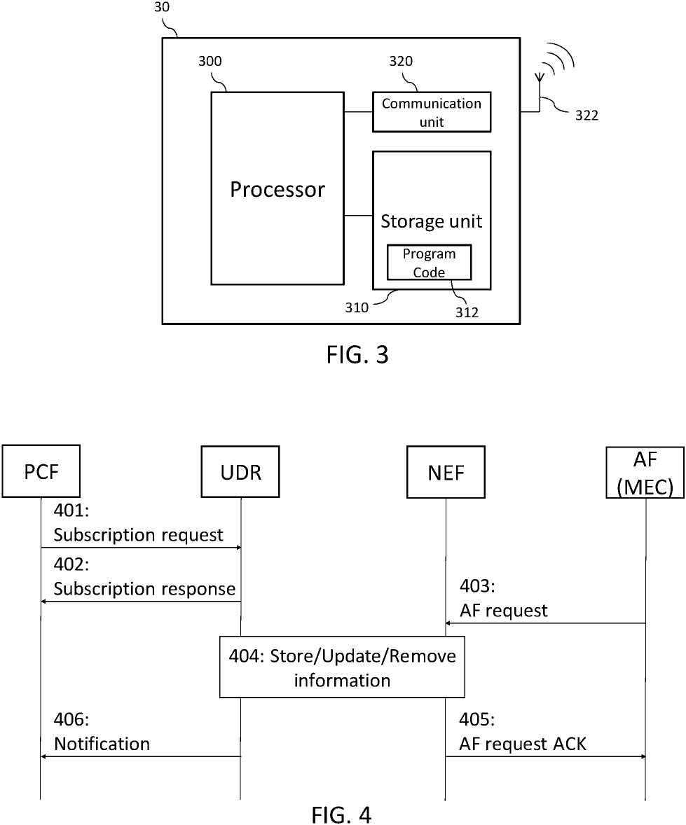

FIG. 3 relates to a schematic diagram of a wireless network node 30 according to an embodiment of the present disclosure. The wireless network node 30 may be a network device, a satellite, a base station (BS), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless network node 30 may comprise (perform) at least one network function and/or at least one service such as an access and mobility management function (AMF), a session management function (SMF), a user place function (UPF), a policy control function (PCF), an application function (AF), a network exposure function (NEF), an RAN network information service (RNIS), a multi-access edge computing (MEC), etc. The wireless network node 30 may include a processor 300 such as a microprocessor or ASIC, a storage unit 310 and a communication unit 320. The storage unit 310 may be any data storage device that stores a program code 312, which is accessed and executed by the processor 300. Examples of the storage unit 312 include but are not limited to a SIM, ROM, flash memory, RAM, hard-disk, and optical data storage device. The communication unit 320 may be a transceiver and is used to transmit and receive signals (e.g. messages or packets) according to processing results of the processor 300. In an example, the communication unit 320 transmits and receives the signals via at least one antenna 322 shown in FIG. 3.

In an embodiment, the storage unit 310 and the program code 312 may be omitted. The processor 300 may include a storage unit with stored program code.

The processor 300 may implement any steps described in exemplified embodiments on the wireless network node 30, e.g., via executing the program code 312.

The communication unit 320 may be a transceiver. The communication unit 320 may as an alternative or in addition be combining a transmitting unit and a receiving unit configured to transmit and to receive, respectively, signals to and from a wireless terminal (e.g. a user equipment).

In an embodiment, the NEF (and/or the AF (MEC)) may subscribe at least one event and/or radio access network information (i.e. RAN information) in the RAN via a control plane signaling. Under such a condition, the RAN may transmit, report or notify the at least one event and/or the RAN information towards the NEF directly or via the user plane. In an embodiment, after receiving the at least one event and/or the RAN information, the NEF may subscribe new event and/or adjust the existing event directly towards the RAN.

The following embodiments illustrate more details of how the NEF subscribes the event and/or the RAN information in the RAN and how the RAN reports the subscribed event and/or the RAN information to the NEF (or to other network functions of the core network). Note that skilled person in the art should acknowledge that these embodiments may be implemented individually or in any possible combination.

### Embodiment 1

In this embodiment, the AF may request the RAN information of the RAN through the core network.

FIG. 4 shows a schematic diagram of a process according to an embodiment of the present disclosure. In FIG. 4, the PCF performs subscriptions (e.g. transmits corresponding subscription request) in the UDR to any modification of application data (step 401). Generally, the UDR that the PCF is configured to subscribe is deployed close to the PCF. For example, the PCF may only subscribe the event (e.g. modification) in the UDR in the same province or the same region.

In step 402, the UDR stores the subscription and sends a response to the PCF.

In step 403, the AF sends (e.g. transmits) an AF request (e.g. a request for RAN information which may be called as RAN information request hereinafter) to the NEF (RNIS). The contents of the AF request may contain the following information:

### A) The Address (e.g. Internet Protocol (IP) Address or Ethernet Address) of the UE, a DNN (Data Network Name), S-NSSAI (Single-Network Slice Selection Assistance Information)

This information is used to identify PDU sessions which are subjects for the AF request message. In an embodiment, the AF request message may target an already established PDU session. Under such a condition, the address of the UE is included. In an embodiment, the AF request message may target a future PDU session (currently not exist). In this embodiment, only the DNN and the S-NSSAI are included.

### B) GPSI (Generic Public Subscription Identifier) And/Or External Group Identifier

The GPSI and/or the external group identifier is used to identify a particular UE or a group of UEs. The NEF may convert the external group identifier into an internal group identifier. If none of the GPSI and the external group identifier is provided, the AF request message targets for any UE.

### C) Quality-Of-Service (QoS) Monitoring

The AF requests to monitor a QoS latency between the UE and anchor UPF. When the QoS latency reaches a threshold, the core network (e.g. 5G system) reports a packet delay towards the AF. This latency request may be requested per UE basis, or per service data flow basis. The AF may request reports of the downlink (DL) packet delay, uplink (UL) packet delay and/or round-trip packet delay.

### D) Alternative QoS Reference

The alternative QoS reference is an array indicating alternative QoS requirements for each traffic filter. The PCF/SMF generates alternative QoS profiles for associated guaranteed bit rate (GBR) QoS flow(s). The RAN may select one suitable QoS profile for the GBR QoS flow(s) based on current radio condition and notify the AF a reference index of the selected QoS profile/QoS requirement. Thus, the AF is able to know the current QoS condition and adjust the application layer traffic.

### E) Radio Network Information Request

The RAN information request may contain information of target RAN and/or event(s) related to the target RAN. In an embodiment, the event(s) related to the target RAN includes at least one of:

### Detecting Cell Change

When the RAN detects the cell change, the RAN reports its latest cell information.

### Detecting Radio Access Bearer (RAB) Establishment/Modification/Release

When detecting an establishment, modification and/or release of the RAB, the RAN reports the latest RAB information

### Performing Measurement

When the RAN performs new UE measurement, the RAN reports corresponding UE measurement report.

### Performing UE Timing Advance (TA) Measurement

When the RAN performs new UE TA measurements, the RAN reports corresponding UE TA measurement.

### (Re)Configuring Carrier Aggregation for the UE

When the UE (re)configures carrier aggregation for the UE, the RAN reports the new carrier aggregation configuration.

### Expiry of Subscription

When detecting an expiry of an existing subscription, the RAN reports the subscription expires.

In an embodiment, the AF request (i.e. RAN information request) may also contain an AF transaction identifier.

In step 404: The NEF ensures the necessary authorization control, including throttling of AF requests, mapping from the information provided by the AF into information needed by the core network (e.g. 5G core network). For example, the NEF may map the AF-service-identifier to the DNN and the S-NSSAI or map the external group identifier to the internal group identifier.

In addition, the NEF transmits the AF request information to the UDR and stores the AF request information as application data in the UDR. In an embodiment, when the AF requests the RAN information, the NEF stores a RAN information subscription container in the UDR. The RAN information subscription container includes at least one of information related to target RAN and a notification target in the NEF, wherein the notification target includes a uniform resource identifier (URI) which is the address to receive corresponding notification and to correlate the notification with the subscription. In an embodiment, the RAN information subscription container may also include the requested event (e.g. the event comprised in the RAN information request). As an alternative or in addition, the NEF may subscribe the event related to the target RAN at later stage.

In step 405, the NEF responds to the AF via an AF response.

In step 406, the PCF(s) which has subscribed the notification from the UDR in the step 401 receives a notification (e.g. Nudr_DM _Notify notification) of application data change from the UDR and stores the notification of application data changing locally.

### Embodiment 2

In this embodiment, the core network sends the subscription towards the RAN.

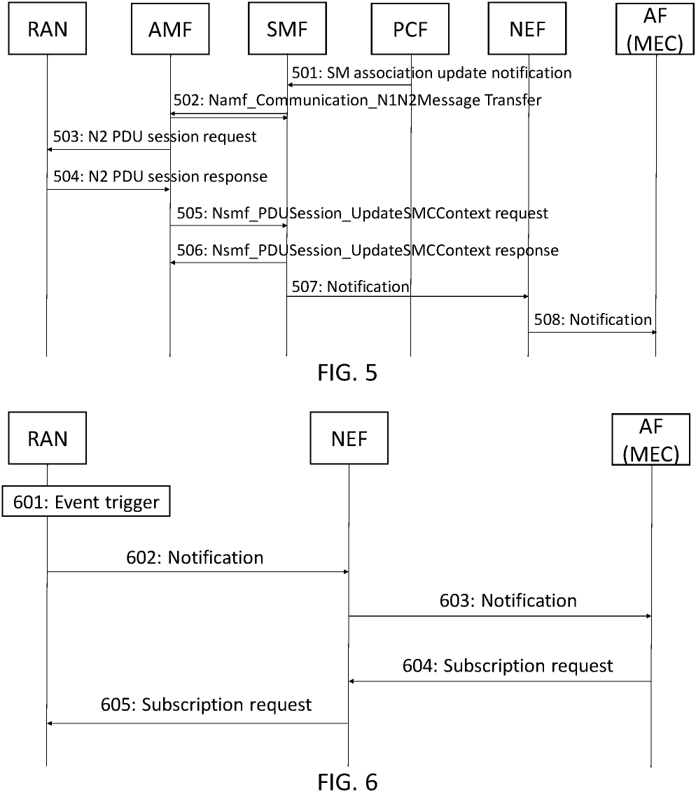

FIG. 5 shows a schematic diagram of a process according to an embodiment of the present disclosure. In FIG. 5, the PCF sends a SM association update notification towards the SMF of PDU session(s) (step 501). In an embodiment, the PCF receives the notification of application data change from the UDR, selects PDU session(s) associated to the application data change and transmits the SM association update notification towards the SMF of selected PDU session(s) (e.g. step 406 shown in FIG. 4). In an embodiment, the SM association update notification includes the RAN information subscription container received from the UDR.

In step 502, the SMF sends a Namf_communication_N1N2MessageTransfer message towards the AMF, wherein the Namf_ communication_N1N2MessageTransfer message includes the RAN information subscription container received from the PCF.

In step 503, the AMF sends an N2 PDU session request message towards the RAN, wherein the N2 PDU session request message includes the RAN information subscription container received from the SMF.

In step 504, the RAN responses the AMF with the N2 PDU session response message comprising a RAN information container. In an embodiment, the RAN information container includes a subscription address (e.g. URI) which identifies an address in the RAN for receiving further subscription request and for correlating the further subscription request from the AF and/or NEF with the current subscription. In an embodiment, the subscription address may be specific to single PDU session or single UE.

In step 505, the AMF sends a Nsmf_ PDUSession_UpdateSMContext request to the SMF, wherein the Nsmf_ PDUSession _UpdateSMContext request message includes the RAN information container.

In step 506, the SMF returns a Nsmf_ PDUSession _UpdateSMContext response message to the AMF.

In step 507, the SMF then sends a notification to the NEF, wherein this notification includes the RAN information container. The NEF receives the notification message and stores the subscription address (e.g. URI) in the RAN. In an embodiment, the NEF does not forward the subscription address (e.g. URI) in the RAN in the notification message to the AF (MEC) for security reason.

After receiving the subscription address, the NEF acknowledges the address providing the RAN information. Thus, the NEF is able to send further subscription request for the RAN information towards the subscription address directly, rather than transmitting the subscription request via the control plane.

In an embodiment regarding to the QoS monitoring, the SMF may also report preconfigured downlink/uplink/round trip latency (i.e. Uu latency) between the RAN and the anchor UPF to the NEF. Thus, the NEF is able to calculate the overall latency between the UE and anchor UPF after receiving the Uu latency.

In an embodiment, the requested RAN information for the AF (MEC) may be required to be per service data flow basis. For example, the requested RAN information may need a packet latency for a service data flow. However, the RAN only reports the RAN information per QoS flow basis. Therefore, the SMF may report QoS flow binding information for the service data flow to the NEF. In an embodiment, the QoS flow binding information includes the service data flow information and the associated QoS flow ID (e.g. associated to the service data flow information).

In step 508, based on the QoS flow binding information received from the SMF, the NEF determines the associated service data flow and send a notification towards the AF (MEC), wherein the notification includes the RAN information associated with the service data flow.

In an embodiment, the AF (MEC) may send further subscription request for further RAN information.

### Embodiment 3

In this embodiment, the RAN directly sends notification(s) to the NEF.

FIG. 6 shows a schematic diagram of a process according to an embodiment of the present disclosure. In FIG. 6, the RAN determines (e.g. detects) the event indicated by the subscription request from the NEF (and/or the AF (MEC)) being triggered (e.g. detecting that the cell changes) (step 601). In an embodiment, the NEF (AF (MEC)) may subscribe the event in the RAN via the process shown in FIGS. 4 and/or 5. More specifically, per subscription request, the RAN may send corresponding notification(s) towards the core network (e.g. NEF) immediately, periodically, or after detecting of the event in the subscription request previously received from the NEF as the following:

### QoS Monitoring

The RAN reports the UL/DL/roundtrip packet latency of the Uu (air) interface in the notification when the latency threshold is reached. The report could be per QoS flow basis or per UE basis. The UL/DL/roundtrip packet latency over the Uu interface is considered by the NEF to calculate the overall latency between the UE and the anchor UPF. In an embodiment, the RAN may also calculate the DL packet latency between the RAN and the anchor UPF based on the information provided by the UPF and report the DL packet latency to the NEF. In an embodiment, the DL and UL packet delay between the RAN and the anchor UPF may also be preconfigured or dynamic calculated and sent from the SMF to the NEF.

### Alternative QoS Reference

When the RAN uses a different QoS profile of the GBR QoS flow, the RAN reports a reference index of the current used QoS profile towards the NEF. Accordingly, the NEF knows the current QoS condition and reports the QoS condition to the AF and the AF can adjust the packets delivery rate based on the reported QoS condition.

### Radio Network Information Request

After the RAN detects the event in the RAN information request, the RAN reports the requested RAN information as requested.

In step 602, the RAN sends the notification directly towards the notification target (i.e. notification address) in the NEF, wherein the notification includes the requested RAN information. In an embodiment, the requested RAN information may also include the QoS flow ID of service data flow(s) associated to the requested RAN information.

In step 603, based on the QoS flow binding information received from the SMF and the QoS flow ID received from the RAN, the NEF determines the associated service data flow and sends a notification towards the AF (MEC), wherein the notification includes the RAN information associated with the service data flow. That is, the NEF sends the notification towards the notification target of the AF (MEC), wherein the notification includes the requested RAN information received from the RAN.

In step 604, the AF (MEC) may subscribe further event(s) or adjust the existing event(s) via transmitting subscription request(s) (e.g. radio information request in step 403 shown in FIG. 4) to the NEF.

In step 605, the NEF sends the subscription request(s) towards the subscription address (e.g. URI) in the RAN directly. In this embodiment, the RAN stores the subscription event and may response with acknowledge message to the NEF (not shown in FIG. 6).

### Embodiment 4

In this embodiment, the RAN sends notification (i.e. requested RAN information) via user plane to the NEF.

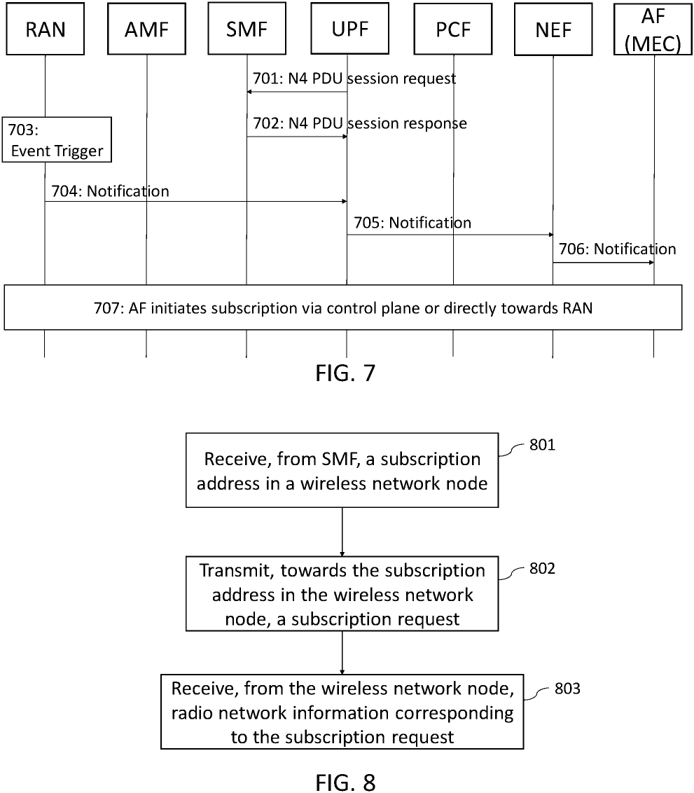

FIG. 7 shows a schematic diagram of a process according to an embodiment of the present disclosure. In FIG. 7, the SMF sends an N4 session modification request to configure the UPF, wherein the N4 session modification request includes the notification address in the NEF. Based on the notification address in the NEF, the UPF is able to forward the notification towards the associated NEF. (step 701)

In an embodiment, the SMF may configure a dedicated QoS flow between RAN and UPF for each NEF, to deliver the corresponding notification. In this embodiment, the SMF provides information to both the UPF and the RAN to configure the dedicated QoS flow. As a result, the RAN is able to send the notification message over the dedicated QoS flow and the UPF is able to detect the notification message based on the QoS flow ID in a GTP-U (general packet radio service tunneling protocol-U) header.

In step 702, the UPF returns an N4 session modification response to the SMF.

In step 703, the RAN determines (e.g. detects) the event indicated by the subscription request from the NEF (and/or the AF (MEC)) being triggered. Per subscription request, the RAN may send corresponding notification towards the core network (e.g. NEF) immediately, periodically, or after detecting the event in the subscription request previously received from the NEF as the follows:

### QoS Monitoring

The RAN reports the UL/DL/roundtrip packet latency of the Uu (air) interface if the latency threshold is reached. This report could be per QoS flow basis or per UE basis. The UL/DL/roundtrip packet latency over the Uu interface is considered by the NEF to calculate the overall latency between the UE and anchor UPF. In an embodiment, the RAN may also calculate the DL packet latency between the RAN and the anchor UPF based on the information provided by the UPF and report the DL packet latency to the NEF. In an embodiment, the UPF also calculates the UL packet delay and sends the UL packet delay to the NEF in subsequent step (e.g. step 705). In an embodiment, the DL and UL packet delay between the RAN and the anchor UPF may be preconfigured or dynamically calculated and sent from the SMF to the NEF.

### Alternative QoS Reference

When the RAN uses a different QoS profile of the GBR QoS flow, the RAN reports a reference index of the current used QoS profile towards the NEF. Accordingly, the NEF acknowledges the current QoS condition and reports the QoS condition to the AF.

### Radio Network Information Request

After the RAN detects the event in the RAN information request, the RAN reports the requested (e.g. subscribed) RAN information as requested.

In step 704, the RAN sends the notification via user plane of the PDU session towards UPF, wherein the notification includes the requested RAN information and the associated QoS flow ID(optional).

In step 705, based on the forwarding information provided by the SMF, the UPF forwards the notification towards the notification target (notification address) of the associated NEF, wherein the forwarded notification may include the requested RAN information and associated QoS flow ID (optional).

Regarding to the QoS monitoring, the UPF may calculate the UL packet delay based on the information provided by the RAN and report the UL packet delay towards the NEF.

In step 706, based on the QoS flow binding information received from the SMF and the QoS flow ID received from the RAN, the NEF determines the associated service data flow and sends the notification towards the notification target of the AF (MEC), wherein the sent notification includes the requested RAN information received from the RAN.

In step 707, the AF (MEC) may subscribe further event(s) via the NEF. In an embodiment, the NEF may send a new subscription request towards the RAN via the control plane as described in Embodiments 1 and 2. As an alternative or in addition, the NEF may send the new subscription request directly towards the RAN as described in Embodiment 3 (e.g. steps 604 and 605).

FIG. 8 shows a flowchart of a process according to an embodiment of the present application. The process may be utilized in the NEF (RNIS) and comprise the following steps:

Step 801: Receive, from the SMF, a subscription address in the RAN;

Step 802: Transmit, towards the subscription address in the RAN, a subscription request; and

Step 803: Receive, from the RAN, RAN information corresponding to (e.g. associated to) the subscription request.

In this embodiment, the NEF may receive, from the SMF of the core network, the subscription address in the RAN for transmitting subsequent subscription request(s) for specific RAN information. After receiving the subscription address, the NEF transmits the subscription request directly to the RAN and receives the subscribed RAN information directly from the wireless network.

In an embodiment, the NEF may receive, from the AF, RAN information request for the specific RAN information and transmit a subscription container comprising the RAN information request and a notification address in the NEF. In an embodiment, the radio information request comprises at least one of information related to the RAN or at least one event related to the RAN. In an embodiment, the notification address in the NEF is utilized for receiving the subscribed RAN information (e.g. notification of the subscribed event).

In an embodiment, the NEF may include the at least one subscribed event(s) in the subscription request (i.e. step 802).

In an embodiment, the at least one subscribed event comprises at least one of:
detecting a cell change,
detecting a radio access bearer event related to a radio access bearer, wherein the radio access bearer event comprises at least one of establishment, a modification or a release,
performing a measurement of a wireless terminal (e.g. UE),
configuring carrier aggregation for a wireless terminal, or
expiry of the subscription request.

In an embodiment, the NEF receives QoS flow binding information from the SMF, wherein the QoS flow binding information may comprise service data flow information and the QoS flow ID associated to the service data flow information. In addition, the NEF may receive QoS flow identifier associated to the subscribed RAN information from the RAN, the SMF or the UPF. Based on the QoS flow binding information and the at least one QoS flow identifier, the NEF is able to transmit, to the AF, the subscribed RAN information per service data flow identifier basis.

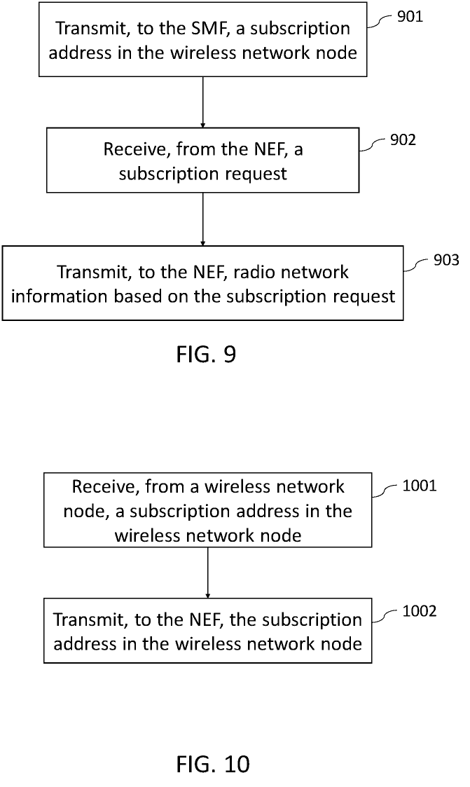

FIG. 9 shows a flowchart of a process according to an embodiment of the present disclosure. The process shown in FIG. 9 may be utilized in a RAN and comprise the following steps:
Step 901: Transmit, to the SMF, a subscription address in the RAN;
Step 902: Receive, from the NEF, a subscription request; and
Step 903: Transmit, to the NEF, RAN information based on the subscription request.

More specifically, the RAN transmits, to the SMF, the subscription address in the RAN, for receiving subsequent subscription request(s). Next the RAN receives the subscription request from the NEF and transmits the subscribed RAN information based on the subscription request.

In an embodiment, the RAN receives, from the AMF, a subscription container comprising RAN information request and a notification address of the network exposure function for the RAN information.

In an embodiment, the RAN information request comprises at least one of information related to the RAN or at least one event related to the RAN.

In an embodiment, the subscription request comprises at least one event related to the RAN.

In an embodiment, the at least one event related to the RAN comprises at least one of:
detecting a cell change,
detecting a radio access bearer event related to a radio access bearer, wherein the radio access bearer event comprises at least one of establishment, a modification or a release,
performing a measurement of a wireless terminal,
configuring carrier aggregation for a wireless terminal, or
expiry of the subscription container.

In an embodiment, the RAN further transmits QoS flow identifier(s) associated to the subscribed RAN information to the NEF.

FIG. 10 shows a flowchart of a process according to an embodiment of the present disclosure. The process shown in FIG. 10 may be utilized in the SMF and comprise the following steps:
Step 1001: Receive, from a RAN, a subscription address in the RAN; and
Step 1002: Transmit, to the NEF, the subscription address in the RAN.

In FIG. 10, the SMF receives, from the RAN a subscription address in the RAN, wherein the subscription address is used for receiving subscription request for RAN information. Next the SMF transmits (e.g. forwards) the subscription address in the RAN to the NEF.

In an embodiment, the SMF receives, from the PCF, a subscription container comprising a RAN information request and a notification address in the network exposure function and transmits, to the RAN, the subscription container.

In an embodiment, the SMF may transmit forwarding information to the UPF, wherein the forwarding information comprising the notification address in the NEF. Accordingly, the UPF is able to transmit corresponding notification (e.g. subscribed RAN information) to the NEF.

In an embodiment, the RAN information request comprises at least one of information related to the RAN or at least one event related to the RAN.

In an embodiment, the subscription request comprises at least one event related to the RAN.

In an embodiment, the at least one event related to the RAN comprises at least one of:
detecting a cell change,
detecting a radio access bearer event related to a radio access bearer, wherein the radio access bearer event comprises at least one of establishment, a modification or a release,
performing a measurement of a wireless terminal,
configuring carrier aggregation for a wireless terminal, or
the expiry of the subscription request.

In an embodiment, the SMF further transmits at least one QoS flow identifier (associated to the RAN information to the NEF). For example, the SMF may transmit the QoS flow identifier(s) along with the associated RAN information to the NEF.

In an embodiment, the SMF further transmits QoS flow binding information to the NEF. The QoS flow binding information includes service data flow information and associated QoS flow ID.

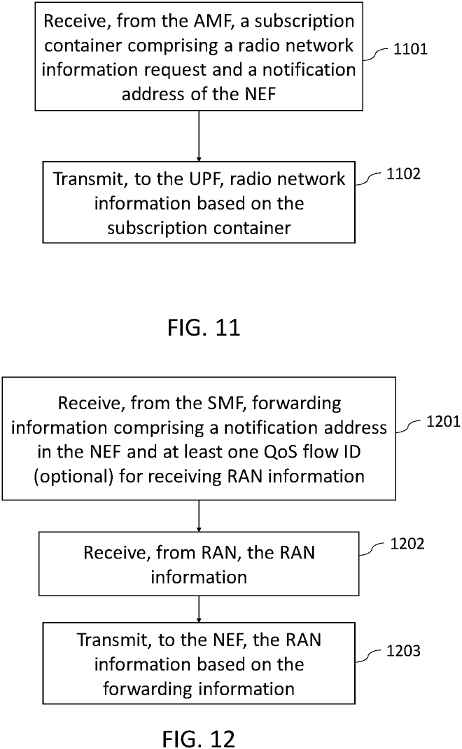

FIG. 11 shows a flowchart of a process according to an embodiment of the present disclosure. The process shown in FIG. 11 may be utilized in a RAN and comprises the following steps:
Step 1101: Receive, from the AMF, a subscription container comprising a RAN information request and a notification address of the NEF; and
Step 1102: Transmit, to the UPF, RAN information based on the subscription container.

In this embodiment, the RAN receives the subscription request (e.g. the RAN information request) via control plane and transmits the subscribed RAN information via user plane. More specifically, the RAN receives the subscription container comprising a RAN information request and a notification address of the NEF. Based on the subscription container, the RAN transmits subscribed RAN information to the UPF, so as to transmit the subscribed RAN information to the NEF and/or the AF via user plane.

In an embodiment, the RAN information request comprises at least one of information related to the RAN or at least one event related to the RAN.

In an embodiment, the at least one event related to the RAN comprises at least one of:
detecting a cell change,
detecting a radio access bearer event related to a radio access bearer, wherein the radio access bearer event comprises at least one of establishment, a modification or a release,
performing a measurement of a wireless terminal,
configuring carrier aggregation for a wireless terminal, or
expiry of the network information request.

In an embodiment, the RAN transmits at least one QoS flow identifier associated to the subscribed RAN information to the UPF.

In an embodiment, the RAN receives, from the SMF, information of configuring a dedicated QoS flow for transmitting the subscribed RAN information.

FIG. 12 shows a flowchart of a process according to an embodiment of the present disclosure. The process shown in FIG. 12 may be utilized in the UPF and comprise the following steps:
Step 1201: Receive, from the SMF, forwarding information comprising a notification address in the NEF and at least one QoS flow ID (optional) for receiving RAN information;
Step 1202: Receive, from a RAN, the RAN information; and
Step 1203: Transmit, to the NEF, the RAN information based on the forwarding information.

In FIG. 12, the UPF receives the forwarding information from the SMF, wherein the forwarding information comprises the notification address in the NEF for receiving the subscribed RAN information. Next, the UPF receives the subscribed RAN information from the RAN and forwards the subscribed RAN information based on the forwarding information to the NEF.

In an embodiment, the UPF may receive at least one QoS flow identifier associated to the RAN information from the RAN. In this embodiment, the UPF may transmit the received QoS flow identifier to the NEF, e.g., along with the RAN information.

In an embodiment, the UPF determines the QoS flow identifier associated to the RAN information, e.g. based on the forwarding information, and transmits the determined QoS flow identifier to the NEF.

In an embodiment, the UPF receives, from the SMF, information of configuring a dedicated QoS flow for receiving the RAN information.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a network exposure function, the wireless communication method comprising:
receiving, from a session management function of a core network, a subscription address in a radio access network,
transmitting, towards the subscription address in the radio access network, a subscription request, and
receiving, from the radio access network, radio access network information corresponding to the subscription request.

2. The wireless communication method of claim 1, further comprising:
receiving, from an application function of the core network, radio access network information request for the radio access network information, and
transmitting, to a unified data repository, a subscription container comprising the radio access network information request and a notification address in the network exposure function for the radio access network information.

3. The wireless communication method of claim 2, wherein the radio access network information request comprises at least one of information related to the radio access network or at least one event related to the radio access network, wherein the at least one event related to the radio access network comprises at least one of:
detecting a cell change,
detecting a radio access bearer event related to a radio access bearer, wherein the radio access bearer event comprises at least one of establishment, a modification or a release,
performing a measurement of a wireless terminal,
configuring carrier aggregation for a wireless terminal, or
expiry of the subscription request.

4. The wireless communication method of claim 1, wherein the subscription request comprises at least one event related to the radio access network, wherein the at least one event related to the radio access network comprises at least one of:
detecting a cell change,
detecting a radio access bearer event related to a radio access bearer, wherein the radio access bearer event comprises at least one of establishment, a modification or a release,
performing a measurement of a wireless terminal,
configuring carrier aggregation for a wireless terminal, or
expiry of the subscription request.

5. (canceled)

6. The wireless communication method of claim 1, further comprising:
receiving, from the session management function, quality-of-service flow binding information,
receiving, from the wireless terminal, the radio access network or a user plane function, at least one quality-of-service flow identifier, and
transmitting, to an application function, the radio access network information based on the quality-of-service binding information and the at least one quality-of-service flow identifier.

7. A wireless communication method for use in a radio access network, the wireless communication method comprising:
transmitting, to a session management function, a subscription address in the radio access network,
receiving, from a network exposure function, a subscription request, and
transmitting, to the network exposure function, radio access network information based on the subscription request.

8. The wireless communication method of claim 7, further comprising:
receiving, from an access and mobility management function, a subscription container comprising a radio access network information request and a notification address of the network exposure function for the radio access network information.

9. The wireless communication method of claim 8, wherein the radio access network information request comprises at least one of information related to the radio access network or at least one event related to the radio access network, wherein the at least one event related to the radio access network comprises at least one of:
detecting a cell change,
detecting a radio access bearer event related to a radio access bearer, wherein the radio access bearer event comprises at least one of establishment, a modification or a release,
performing a measurement of a wireless terminal,
configuring carrier aggregation for a wireless terminal, or
expiry of the subscription container.

10. The wireless communication method of claim 7, wherein the subscription request comprises at least one event related to the radio access network, wherein the at least one event related to the radio access network comprises at least one of:
detecting a cell change,
detecting a radio access bearer event related to a radio access bearer, wherein the radio access bearer event comprises at least one of establishment, a modification or a release,
performing a measurement of a wireless terminal,
configuring carrier aggregation for a wireless terminal, or
expiry of the subscription container.

11. (canceled)

12. The wireless communication method of claim 7, further comprising:
transmitting, to the network exposure function, at least one quality-of-service flow identifier and the radio access network information.

13. A wireless communication method for use in a session management function, the wireless communication method comprising:
receiving, from a radio access network, a subscription address in the radio access network, and
transmitting, to a network exposure function, the subscription address in the radio access network.

14. The wireless communication method of claim 13, further comprising:
receiving, from a policy control function, a subscription container comprising a radio access network information request and a notification address in the network exposure function, and
transmitting, to the radio access network, the subscription container.

15. The wireless communication method of claim 14, further comprising:
transmitting, to a user plane function, forwarding information comprising the notification address in the network exposure function.

16. The wireless communication method of claim 14, wherein the radio access network information request comprises at least one of information related to the radio access network or at least one event related to the radio access network, wherein the at least one event related to the radio access network comprises at least one of:
detecting a cell change,
detecting a radio access bearer event related to a radio access bearer, wherein the radio access bearer event comprises at least one of establishment, a modification or a release,
performing a measurement of a wireless terminal,
configuring carrier aggregation for a wireless terminal, or
expiry of the subscription request.

17. The wireless communication method of claim 13, wherein the subscription request comprises at least one event related to the radio access network, wherein the at least one event related to the radio access network comprises at least one of:
detecting a cell change,
detecting a radio access bearer event related to a radio access bearer, wherein the radio access bearer event comprises at least one of establishment, a modification or a release,
performing a measurement of a wireless terminal,
configuring carrier aggregation for a wireless terminal, or
expiry of the subscription request.

18. (canceled)

19. The wireless communication method of claim 13, further comprising:
transmitting, to the network exposure function, quality-of-service flow binding information.

20-27. (canceled)

28. A network device, comprising:
at least one processor; and
a memory, which is configured to store at least one program;
wherein the at least one program, when executed by the at least one processor, enables the at least one processor to perform the method of claim 1.

29. (canceled)

30. A radio access network, comprising:
at least one processor; and
a memory, which is configured to store at least one program;
wherein the at least one program, when executed by the at least one processor, enables the at least one processor to perform the method of claim 7.

31. (canceled)

32. A network device, comprising:
at least one processor; and
a memory, which is configured to store at least one program;
wherein the at least one program, when executed by the at least one processor, enables the at least one processor to perform the method of claim 1.

33-37. (canceled)

38. A computer program product comprising a computer-readable program medium code stored thereupon, the code, when executed by a processor, causing the processor to implement a wireless communication method recited in claim 1.
